(19) United States
(12) Patent Application Publication
(10) Pub. No.: US 2026/0310925 A1
(43) Pub. Date: Oct. 8, 2026

(54) METHOD, TERMINAL, AND SMART CARD FOR REGISTERING AND RECOGNIZING FINGERPRINT

(71) Applicant: Samsung Electronics Co., Ltd., Suwon-si (KR)

(72) Inventor: Sumin Park, Suwon-si (KR)

(21) Appl. No.: 19/389,757

(22) Filed: Nov. 14, 2025

(30) Foreign Application Priority Data
Apr. 3, 2025 (KR) 10-2025-0043668

(51) Int. Cl. G06K 19/077; G06K 19/07; G06K 19/073; G06V 40/12; G06V 40/13; G06V 40/50; H04B 5/43

(52) U.S. Cl. CPC G06K 19/07777; G06K 19/0723; G06K 19/07354; G06V 40/1306; G06V 40/1365; G06V 40/55; H04B 5/43

(57) ABSTRACT

A terminal includes a near field communication (NFC) antenna, an NFC module configured to emit a first radio frequency (RF) signal through the NFC antenna, and configured to acquire digital data from an analog signal generated from a second RF signal received by the NFC antenna, and a processor configured to execute an application for providing a first user interface using the digital data. The digital data includes power data of a smart card emitting the second RF signal. The processor is configured to output the power data to a first user interface of the terminal to present a representation of a power state of the smart card.

### CROSS-REFERENCE TO RELATED APPLICATION(S)

This application claims benefit of priority to Korean Patent Application No. 10-2025-0043668 filed on Apr. 3, 2025, in the Korean Intellectual Property Office, the disclosure of which is incorporated herein by reference in its entirety.

### BACKGROUND

The present inventive concept relates to smart cards and the use thereof.

A smart card, also referred to as a chip card or IC card, may receive power through a radio frequency (RF) signal based on near field communication (NFC) by tagging the smart card to an external terminal such as a smartphone. NFC technology, a communication technology enabling data exchange over short distances using a specific frequency band, has been applied in various fields due to advantages such as high security performance. To utilize an NFC function, the smart card must be positioned at an appropriate distance from the external terminal so as to generate a sufficient power voltage using an RF signal emitted by the external terminal operating in a reader mode. Various methods have been proposed for finding an optimal tagging position.

### SUMMARY

An aspect of the present inventive concept is to provide a method and apparatus for guiding an optimal position for near field communication (NFC) communication when a smart card is tagged to an external terminal.

According to an aspect of the present inventive concept, there is provided a terminal including a near field communication (NFC) antenna, an NFC module configured to emit a first radio frequency (RF) signal through the NFC antenna, and configured to acquire digital data from an analog signal generated from a second RF signal received by the NFC antenna, and a processor configured to execute an application for providing a first user interface using the digital data. The digital data may include power data of a smart card emitting the second RF signal. The processor may be configured to output the power data to the first user interface of the terminal to present a representation of a power state of the smart card.

According to another aspect of the present inventive concept, there is provided a method for registering and recognizing a fingerprint, the method including transmitting a first RF signal to an external smart card through an NFC antenna of a terminal, receiving a second RF signal from the external smart card in response to the first RF signal, demodulating the second RF signal to acquire power data generated by the external smart card using the first RF signal, outputting the power data to a first user interface of the terminal to cause the first user interface to present a representation of a power state of the external smart card, and outputting, to the first user interface, a notification indicating a readiness for one of fingerprint registration or fingerprint recognition, based on the power data.

According to another aspect of the present inventive concept, there is provided a smart card including an NFC antenna configured to output, in response to receiving a first RF signal emitted by an external terminal, an analog signal, a rectifier configured to rectify the analog signal and output a rectification voltage, a voltage regulator configured to provide a power voltage using the rectification voltage, a power state detector including a current mirror transistor configured to copy a current input from the rectifier to the voltage regulator, the power state detector configured to generate power data representing a power state of the smart card using a mirror current output by the current mirror transistor, and a modulator configured to output, to the NFC antenna, a transmission clock signal modulated based on the power data.

### BRIEF DESCRIPTION OF DRAWINGS

The above and other aspects, features, and advantages of the present inventive concept will be more clearly understood from the following detailed description, taken in conjunction with the accompanying drawings, in which:

FIG. 1 is a diagram illustrating an external terminal including an application and a smart card according to an example embodiment of the present inventive concept;

FIG. 2 is a diagram illustrating an operation of tagging a smart card to an external terminal according to an example embodiment of the present inventive concept;

FIG. 3 is a diagram illustrating an NFC communication process according to an example embodiment of the present inventive concept;

FIG. 4 is a block diagram illustrating an internal configuration of a terminal according to an example embodiment of the present inventive concept;

FIG. 5 is a block diagram illustrating an internal configuration of a smart card according to an example embodiment of the present inventive concept;

FIG. 6 is a diagram illustrating a power data generation process of a smart card according to an example embodiment of the present inventive concept;

FIG. 7 is a diagram illustrating a first user interface based on a magnitude of received power according to an example embodiment of the present inventive concept;

FIG. 8 is a diagram illustrating a process of performing fingerprint registration according to an example embodiment of the present inventive concept;

FIG. 9 is a diagram illustrating a process of performing fingerprint recognition according to an example embodiment of the present inventive concept;

FIG. 10 is a flowchart illustrating a method for registering a fingerprint according to an example embodiment of the present inventive concept;

FIGS. 11 and 12 are flowcharts illustrating methods for recognizing a fingerprint according to an example embodiment of the present inventive concept; and

FIG. 13 is an operation diagram illustrating an operation process of a terminal and a smart card according to an example embodiment of the present inventive concept.

### DETAILED DESCRIPTION

Hereinafter, example embodiments of the present inventive concept will be described below with reference to the accompanying drawings. The inventive concept may, however, be embodied in many different forms and should not be construed as limited to the example embodiments set forth herein. It should also be emphasized that the disclosure provides details of alternative examples, but such listing of alternatives is not exhaustive. Furthermore, any consistency of detail between various examples should not be interpreted as requiring such detail.

Throughout the specification, when a component is described as "including" a particular element or group of elements, it is to be understood that the component is formed of only the element or the group of elements, or the element or group of elements may be combined with additional elements to form the component, unless the context indicates otherwise. The term “consisting of,” on the other hand, indicates that a component is formed only of the element(s) listed.

Ordinal numbers such as “first,” “second,” “third,” etc. may be used simply as labels of certain elements, steps, etc., to distinguish such elements, steps, etc. from one another. Terms that are not described using “first,” “second,” etc., in the specification, may still be referred to as “first” or “second” in a claim. In addition, a term that is referenced with a particular ordinal number (e.g., “first” in a particular claim) may be referenced elsewhere without an ordinal number or with a different ordinal number (e.g., “second” in the specification or another claim).

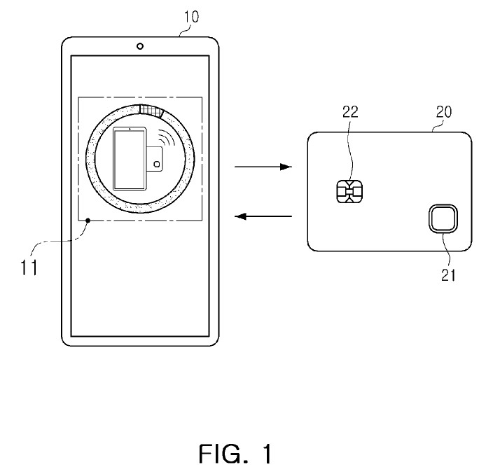

FIG. 1 is a diagram illustrating a terminal implementing an application and a smart card according to an example embodiment.

Referring to FIG. 1, a terminal 10 according to an example embodiment may include a user interface 11 for interacting with the terminal 10. Although the terminal 10 is illustrated as a smartphone, the terminal 10 according to example embodiments may be applied to other mobile devices such as a tablet PC or a laptop computer, and may also be applied to various other devices such as a desktop computer, a home television, a set-top box, a refrigerator, a washing machine, a dryer, or an air conditioner.

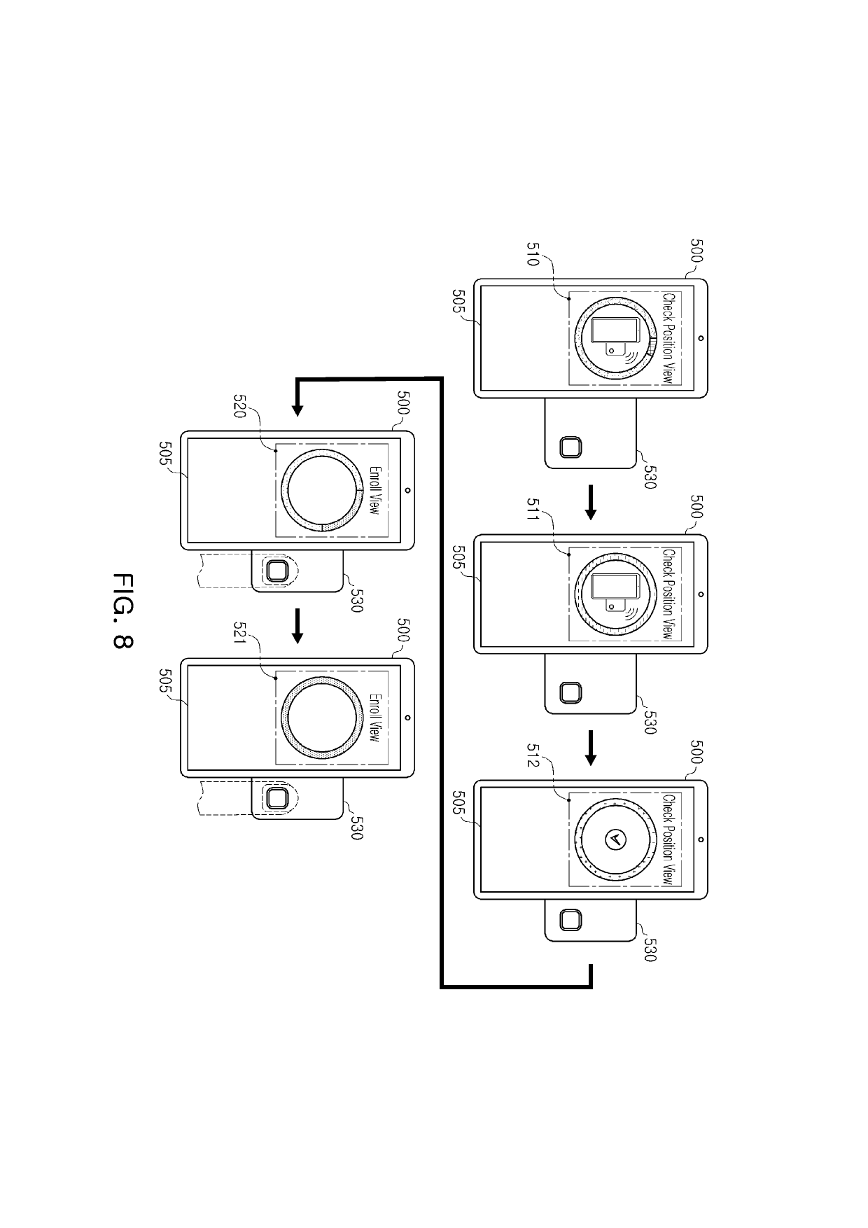

The user interface 11 may be controlled by an application executed by a processor to provide a guide for an optimal tagging position to a user. For example, the user interface 11 may be provided as graphical user interface displayed on a screen of the terminal. Hereinafter, the user interface 11 as displayed by the terminal under control of the application will be described with reference to FIGS. 7 to 9.

The smart card 20 may include, on the exterior thereof, a contact plate 22 and a fingerprint sensor 21. The contact plate 22 of the smart card 20 may serve to transmit payment information data or identity data stored in the smart card through contact with a reader. The fingerprint sensor 21 may be a portion of the smart card contacted by a finger of the user when registering or recognizing a fingerprint on the smart card.

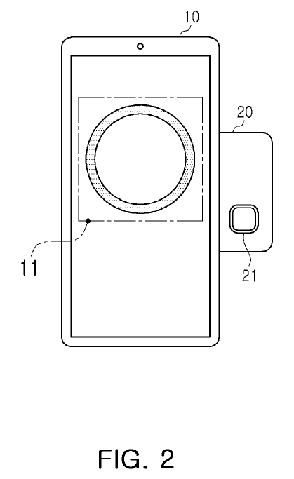

FIG. 2 is a diagram illustrating an operation of tagging a smart card to an external terminal according to an example embodiment of the present inventive concept.

Referring to FIG. 2, an operation of tagging a smart card 20 to a terminal 10 is illustrated. Tagging a smart card to a terminal may refer to the process of positioning a smart card in close proximity to the terminal.

The smart card 20 may receive power from the terminal 10. For example, the smart card 20 may operate without the use of a built-in battery by receiving induced power from the terminal 10 or direct voltage through a tagging operation with the terminal 10.

As illustrated in FIG. 2, the smart card 20 may be tagged to a rear surface of the terminal 10 to be positioned in close proximity to a near field communication (NFC) antenna of the terminal 10. When a user directly tags the smart card 20 to the terminal 10, a distance between the terminal 10 and the smart card 20 during the tagging process may become greater than or equal to a predetermined distance (e.g., a maximum distance for operation of the smart card 20). When the distance becomes greater than or equal to this predetermined distance, the smart card 20 may not receive sufficient power from the terminal 10, and a voltage drop may occur and/or a delay in tagging recognition may result. Accordingly, a guide for tagging the smart card 20 to the terminal 10 such that respective NFC antennas of the smart card 20 and the terminal 10 are brought within the predetermined distance may be useful.

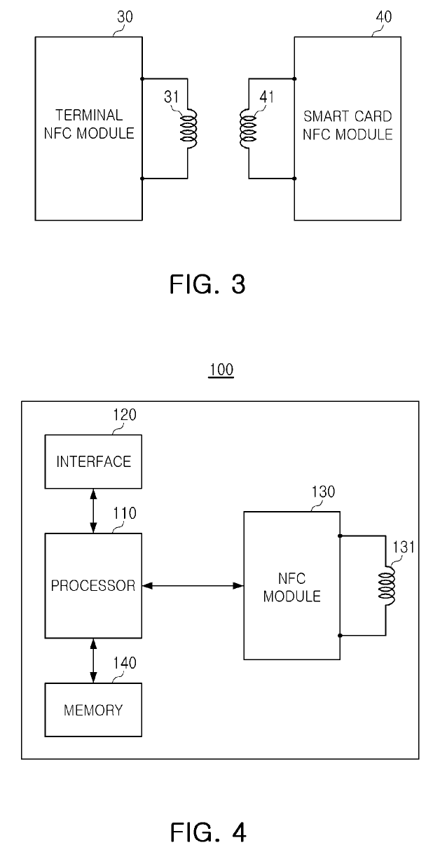

FIG. 3 is a diagram illustrating an NFC communication process according to an example embodiment of the present inventive concept.

Referring to FIGS. 1 and 3 together, the terminal 10 may include an NFC module 30 and an NFC antenna 31, and the smart card 20 may include an NFC module 40 and an NFC antenna 41.

The smart card 20 may perform NFC communication with the terminal 10 through the NFC antenna 41 to receive voltage from the terminal 10 and exchange payment data with the terminal 10. The terminal 10 may perform NFC communication with the smart card 20 through the NFC antenna 31 to receive power data from the smart card 20. In this context, power data may be information about the power state of the smart card.

The terminal NFC module 30 may communicate with an external device such as the smart card 20 or the like using a radio frequency (RF) signal in a specific frequency band. As illustrated in FIG. 1, when the smart card is an NFC tag, the terminal NFC module 30 may operate as a reader for the NFC tag.

The terminal NFC module 30 may communicate with the smart card NFC module 40 using an RF signal in a specific frequency band, for example, 13.56 MHz. When an RF field caused by a signal emitted from the smart card NFC module 40 is detected, the terminal NFC module 30 may perform setting of RF parameters necessary for communication with the smart card 20. For example, the RF parameters may include a frequency, a phase, and the like of a clock signal generated by the terminal NFC module 30.

The terminal NFC module 30 may emit a first RF signal through the NFC antenna 31 and may receive a second RF signal through the NFC antenna 31. The terminal NFC module 30 may process a received analog signal (e.g., the second RF signal) to acquire digital data. The digital data may include power data of the smart card 20.

In this example, the first RF signal may refer to an RF signal emitted from the NFC antenna 31 within the terminal, and the second RF signal may refer to an RF signal emitted from the NFC antenna 41 within the smart card. In addition, the power data may refer to digital data representing a power state of the smart card and may be generated using a copied current of a current output from a rectifier to a voltage regulator within the smart card.

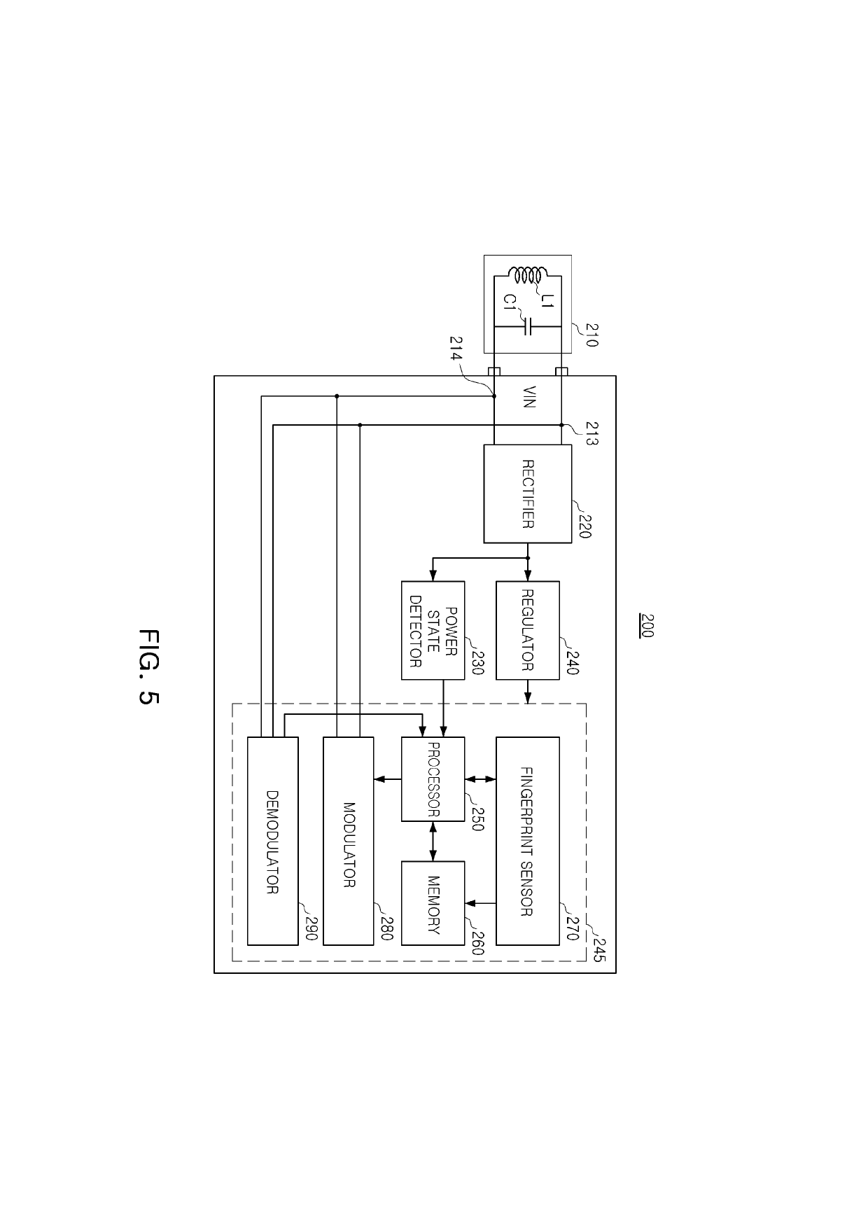

FIG. 4 is a block diagram illustrating an internal configuration of a terminal according to an example embodiment of the present inventive concept.

Referring to FIG. 4, a terminal 100 may include a processor 110, an interface 120, an NFC module 130, an NFC antenna 131, and a memory 140.

The processor 110 may control an overall operation of the terminal 100. The processor 110 may execute applications providing functions of the terminal 100 such as an internet browser, games, video playback, and image capturing. The processor 110 may include a single processor core or a plurality of processor cores. The processor 110 may further include a cache memory device for temporarily storing instructions or data stored in the memory 140.

In addition, the processor 110 may set a level of RF output power transmitted by the NFC module 130 of the terminal 100 to a maximum level in response to performing either fingerprint registration or fingerprint recognition of a smart card. As a result, the NFC module 130 may smoothly supply power to the smart card to perform these operations.

The memory 140 may store data necessary for an operation of the terminal 100. For example, the memory 140 may include a volatile memory device and/or a non-volatile memory device. The volatile memory device may be implemented as a DRAM, SRAM, mobile DRAM, or memory similar thereto. The non-volatile memory device may be implemented as an electrically erasable programmable read-only memory (EEPROM), flash memory, phase change RAM (PRAM), resistance RAM (RRAM), nano floating gate memory (NFGM), polymer RAM (PoRAM), magnetic RAM (MRAM), ferroelectric RAM (FRAM), or memory similar thereto. For example, the memory 140 may store a boot image for booting the terminal 100, and may store output data to be transmitted to an external device, and input data received from the external device.

The NFC module 130 may transmit data provided by the processor 110 and/or the memory 140 to the external device, such as a smart card or the like, through NFC communication, and may receive data from the external device and provide the received data to the processor 110 and/or the memory 140. For example, the NFC module 130 may modulate a signal to include the data provided by the processor 110 and emit the modulated RF signal for transmission to another device. The NFC module 130 may also receive a modulated RF signal from another device and demodulate the RF signal to obtain data contained in the RF signal, such as power data, fingerprint data, or other data. The received data may then be transmitted to the processor. For example, the NFC module 130 may be implemented according to various example embodiments of the present inventive concept.

The NFC antenna 131 may receive RF signals from the external device, such as the smart card or the like, and may also convert a transmission clock signal modulated based on digital data to be transmitted into an RF signal to externally emit the RF signal (e.g., transmit to an external device). For example, the external device, such as the smart card or the like, may generate electrical power from the RF signal emitted externally by the NFC antenna 131 and operate using the generated electrical power. In order for the external device to generate electrical power having a sufficient strength necessary for operation using the RF signal, the external device and the terminal 100 may need to be tagged at an appropriate position or within a certain distance of the appropriate position. In an example embodiment of the present inventive concept, the NFC module 130 may use the RF signal received from the external device (e.g., the second RF signal) to allow the processor 110 to determine a power state of the external device (e.g., the NFC module 130 may transmit a power data representative of the power state to the processor 110).

The processor 110 may output a representation of the power state of the external device through the interface 120, and thus a user may intuitively recognize the power state of the external device with reference to information output through the interface 120 that represents the power state. The interface 120 may include one or more input devices such as a keypad or a touchscreen, and/or one or more output devices such as a speaker or a display device. The interface 120 may include multiple user interfaces such as a first user interface, a second user interface, and a third user interface, which will be described below with reference to FIGS. 7 to 13.

In addition, the terminal 100 may further include a battery, a camera image signal processor (CIS), and a modem such as a baseband chipset. For example, the modem may be a modem processor supporting communication such as GSM, GPRS, WCDMA, or HSxPA.

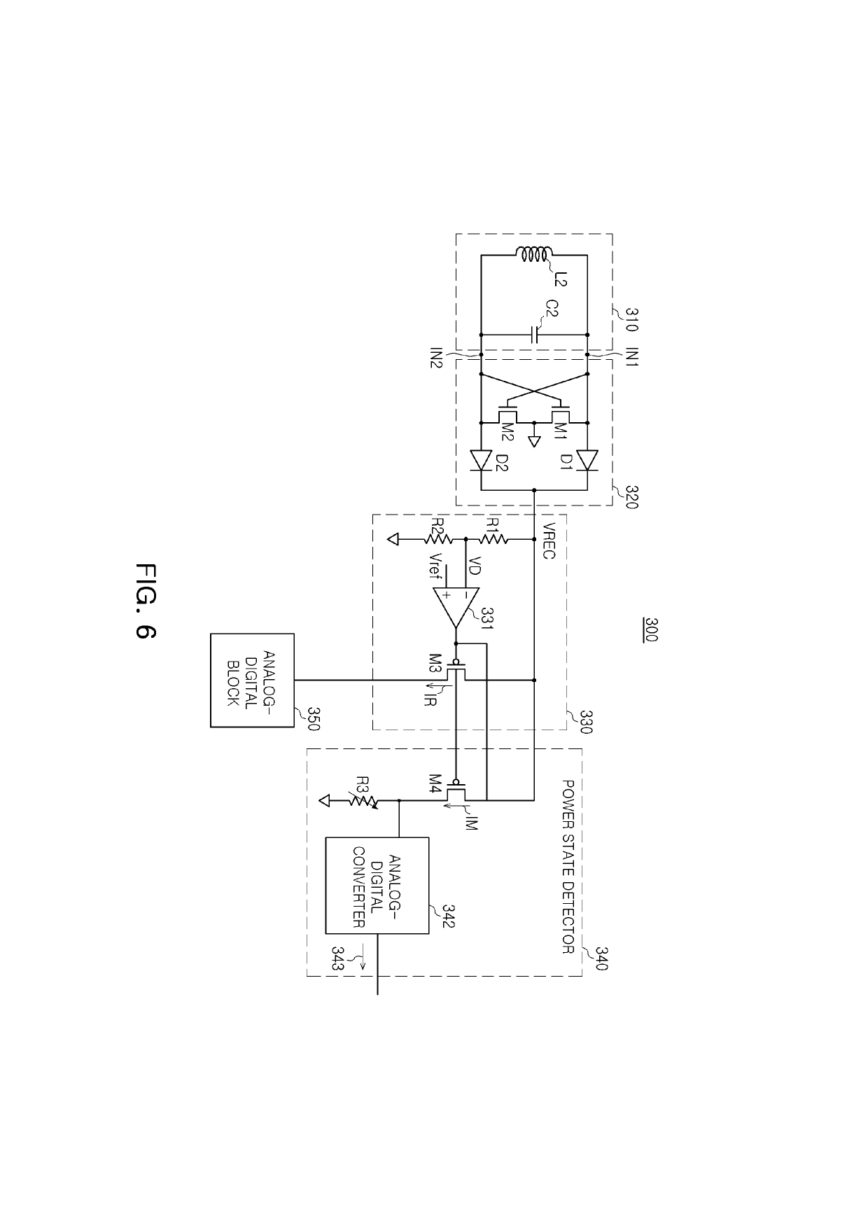

FIG. 5 is a block diagram illustrating an internal configuration of a smart card according to an example embodiment of the present inventive concept.

Referring to FIG. 5, a smart card 200 may include a resonant circuit 210 including an NFC antenna L1 and a capacitor C1, a rectifier 220, a power state detector 230, a voltage regulator 240, a processor 250, a memory 260, a fingerprint sensor 270, a modulator 280, and a demodulator 290.

The resonant circuit 210 may output an input voltage VIN generated by the resonance of the NFC antenna L1 in response to a radio frequency (RF) signal. Here, the input voltage VIN may refer to a voltage difference between a first input node 213 and a second input node 214. In addition, the NFC antenna L1 included in the resonant circuit 210 may receive an external RF signal or transmit an RF signal externally. For example, the NFC antenna L1 may transmit or receive the RF signal for communication with a terminal 10. In order for the NFC antenna L1 to transmit the RF signal, the NFC antenna L1 may receive a signal from the modulator 280 and externally transmit the RF signal.

In an example embodiment, the NFC antenna L1 may be modeled as a parallel circuit of an inductor and a capacitor C1. The NFC antenna L1 may receive an RF signal transmitted from the terminal and convert the received RF signal into an electrical signal through electromagnetic induction.

The rectifier 220 may rectify an analog alternating current (AC) signal received through the NFC antenna L1 and output a rectification voltage. For example, the rectifier 220 may include rectifier circuits using a half-wave rectifier or a full-wave rectifier method. In addition, the rectifier 220 may include a smoothing circuit for smoothing a rectified voltage. However, the rectification method of the rectifier 220 is not limited thereto, and a configuration of the rectifier 220 may be modified and implemented in various manners.

The voltage regulator 240 may perform a regulating operation of detecting a change in level of the rectification voltage and maintaining the rectification voltage at a predetermined level. The voltage regulator 240 may include resistors, a comparator, and a power transistor, but example embodiments according to the technical idea of the present inventive concept are not limited thereto.

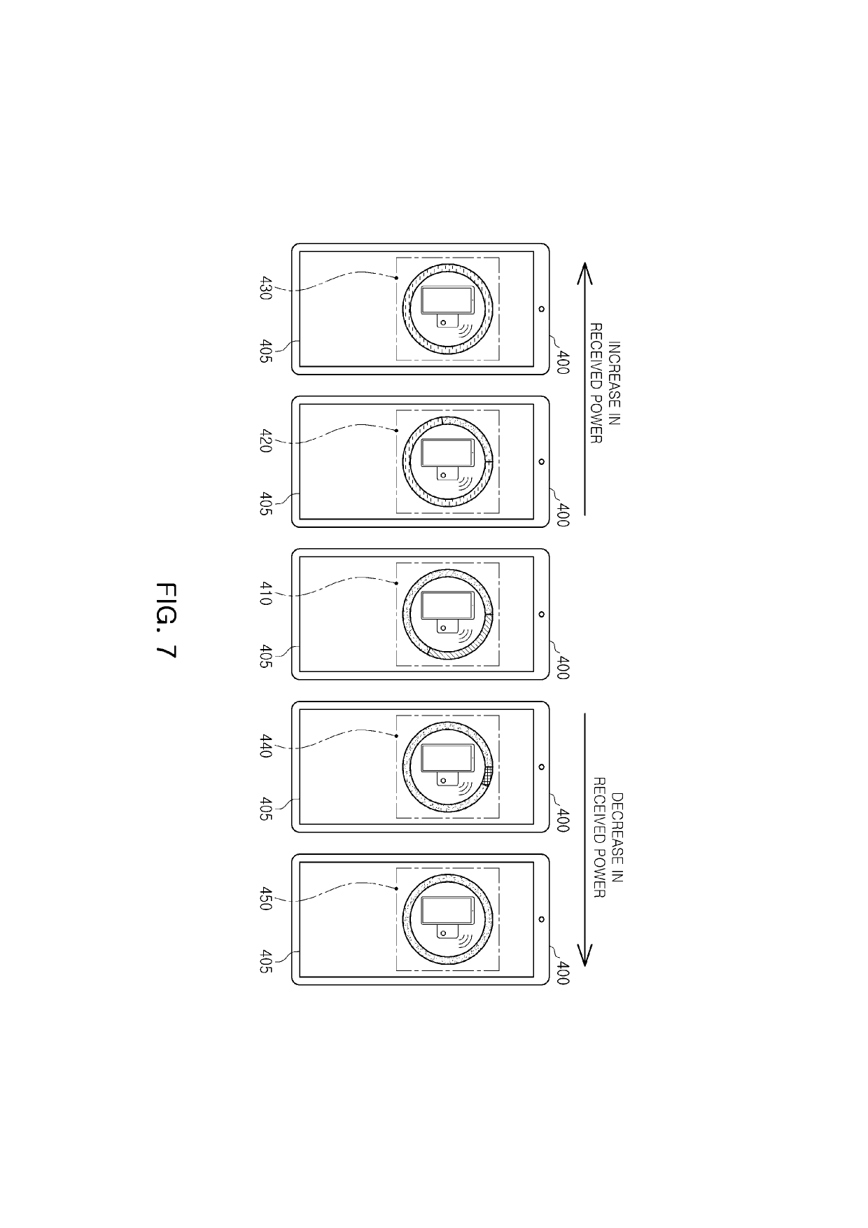

The power state detector 230 may include a current mirror transistor, copying a current input to the voltage regulator 240 from the rectifier 220, and may generate power data using a mirror current output by the current mirror transistor. A more detailed operation process of the rectifier 220, the voltage regulator 240, and the power state detector 230 will be described below with reference to FIG. 6. An analog/digital block 245 may include the processor 250, the memory 260, the fingerprint sensor 270, the modulator 280, and the demodulator 290.

The processor 250 may control an overall operation of the smart card 200. The processor 250 may include a single processor core or a plurality of processor cores. The processor 250 may include a cache memory device temporarily storing instructions or data stored in the memory 260.

The memory 260 may store data necessary for the operation of the smart card 200. For example, the memory 260 may include a volatile memory device and/or a non-volatile memory device. The volatile memory device may be implemented using a DRAM, SRAM, mobile DRAM, or similar memory, and the non-volatile memory device may be implemented using an EEPROM, flash memory, PRAM, RRAM, NFGM, PoRAM, MRAM, FRAM, or memory similar thereto. For example, the memory 260 may store registered fingerprint information, and may provide the fingerprint information to the processor 250.

The fingerprint sensor 270 may be a portion of the smart card that is contacted by a finger of a user when registering a fingerprint and/or recognizing a fingerprint. For example, the fingerprint sensor 270 may include a plurality of sensing electrodes, and may detect a change in capacitance in the plurality of sensing electrodes caused by the contacted fingerprint, thereby generating fingerprint information corresponding to the contacted fingerprint.

The modulator 280 may include a matching circuit, an amplifier, and a clock generator therein, and may serve to modulate digital data such as power data within the smart card into a transmission clock signal and output the transmission clock signal to the NFC antenna L1. For example, the amplifier may externally emit, in response to the transmission clock signal output by the clock generator, an RF signal through the NFC antenna L1. The RF signal emitted through the NFC antenna L1 may include data to be transmitted to a device external to the smart card. For example, the power data may be modulated using an active load modulation (ALM) method, such that the power data or the like may be included in the RF signal and emitted externally.

In an example embodiment of the present inventive concept, an operation of the modulator 280 may be started when the NFC antenna L1 of a smart card enters a space influenced by an RF field generated by an external device, such as a terminal 100, and the smart card 200 detects the field. When the field is detected, the smart card 200 may perform NFC communication with the external device using information stored in the memory. For example, a clock signal generated in the modulator may be input to the amplifier, and the amplifier may amplify the clock signal and output the clock signal to the antenna. Accordingly, an RF signal may be transmitted through the antenna.

The demodulator 290 may include a clock extractor and a phase detector, and may serve to demodulate an RF signal received from an external source by the NFC antenna L1. When an external terminal, such as terminal 100, forms an RF field and emits an RF signal, the RF signal may be received by the NFC antenna L1 of the smart card by electromagnetic induction. The clock extractor may extract a recovered clock signal having a predetermined frequency and phase from the RF signal received by the NFC antenna L1. For example, characteristics such as the frequency and phase of the recovered clock signal generated by the clock extractor may be determined according to the RF signal received by the NFC antenna L1.

The phase detector may compare the recovered clock signal with a predetermined reference clock signal. For example, the reference clock signal may be generated by a phase-locked loop circuit included in the NFC module of the smart card or included in an electronic device together with the NFC module. The phase detector may compare the phase of the recovered clock signal with a phase of the reference clock signal.

FIG. 6 is a diagram illustrating a power data generation process of a smart card according to an example embodiment of the present inventive concept.

Referring to FIG. 6, a smart card 300 according to an example embodiment of the present inventive concept may include a resonant circuit 310 including an NFC antenna L2 and a capacitor C2, a rectifier 320, a voltage regulator 330, a power state detector 340, and an analog/digital block 350.

In this example, the rectifier 320 may include a first switching transistor M1, a second switching transistor M2, a first diode D1, and a second diode D2. In addition, the analog/digital block 350 may include a processor, a memory, a fingerprint sensor, a modulator, and a demodulator, as described with reference to FIG. 5.

The resonant circuit 310 may output an input voltage (VIN in FIG. 5) from a first RF signal. For example, the input voltage (VIN in FIG. 5) may refer to a difference between a voltage of a first input node IN1 and a voltage of a second input node IN2. In an example embodiment, when the smart card 300 enters a field generated by the first RF signal emitted by a terminal, the NFC antenna L2 included in the resonant circuit 310 may output, in response to the first RF signal, an analog signal to the input nodes IN1 and IN2.

In an example embodiment, the rectifier 320 may be implemented as an active diode rectifier, as illustrated in FIG. 6. An AC signal input to both ends of the rectifier 320 may be output as a full-wave rectified rectification voltage VREC.

In an example embodiment, during a period in which the voltage of the first input node IN1 is relatively higher than the voltage of the second input node IN2, the first switching transistor M1 may be turned off, and the second switching transistor M2 may be turned on. Accordingly, the voltage of the first input node IN1 may be output through the first diode D1, and no current may flow through the second diode D2.

Conversely, during a period in which the voltage of the first input node IN1 is relatively lower than the voltage of the second input node IN2, the first switching transistor M1 may be turned on, and the second switching transistor M2 may be turned off. Accordingly, the voltage of the second input node IN2 may be output through the second diode D2, and no current may flow through the first diode D1. As a result, a direction of an output current may be maintained constant, even when phases of the voltage of the first input node IN1 and the voltage of the second input node IN2 are changed.

In an example embodiment, the first diode D1 and the second diode D2 may not only output a rectification voltage VREC obtained by rectifying the voltages of the input nodes IN1 and IN2, but also block reverse current. In addition, the first diode D1 and the second diode D2 may maintain current paths during switching dead periods of the switching transistors M1 and M2, thereby ensuring continuity of current.

The voltage regulator 330 may perform a regulating operation of detecting a change in level of the rectification voltage VREC and maintaining the rectification voltage VREC at a predetermined level. The voltage regulator 330 may include resistors R1 and R2, a comparator 331, and a power transistor M3, but example embodiments according to the technical idea of the present inventive concept are not limited thereto. The resistors of the voltage regulator 330 may transmit a division voltage VD, obtained by dividing the rectification voltage VREC, to an inverting input terminal of the comparator 331. For example, the voltage regulator 330 may convert the rectification voltage VREC having a relatively high voltage level into the division voltage VD having a relatively low voltage level, using the resistors R1 and R2. The converted division voltage VD may be applied to the inverting input terminal of the comparator 331. Accordingly, a change of the rectification voltage VREC may be input to the inverting input terminal of the comparator 331. A reference voltage Vref may be input to a non-inverting input terminal of the comparator 331.

When a voltage level of the division voltage VD is lower than the reference voltage Vref, the comparator 331 may generate an output voltage at a high level (for example, a logic high level H), and may turn off the power transistor M3. Accordingly, a magnitude of a voltage regulator output current IR flowing through the power transistor M3 may decrease, and a voltage level of the rectification voltage VREC may increase.

Conversely, when a voltage level of the division voltage VD input to the inverting input terminal is higher than the reference voltage Vref, the comparator 331 may generate an output voltage at a low level (for example, a logic low level L), and may turn on the power transistor M3. Accordingly, the magnitude of the voltage regulator output current IR flowing through the power transistor M3 may increase, and the voltage level of the rectification voltage VREC may decrease. As described above, the voltage regulator 330 may maintain the voltage level of the rectification voltage VREC at a predetermined level. The voltage level of the rectification voltage VREC controlled by the voltage regulator 330 may be defined by the reference voltage Vref.

Subsequently, the power state detector 340 may include a current mirror transistor M4 copying the voltage regulator output current IR from the rectifier 320. The power state detector 340 may generate power data 343, using a mirror current IM output by the current mirror transistor M4.

An analog-to-digital converter 342 may output, as the power data 343, a representation of the voltage generated by the mirror current IM and a variable resistor R3. The processor may receive the power data 343 from the power state detector 340 and transmit the power data 343 to the modulator.

The modulator 280 may output, to the NFC antenna L2, a transmission clock signal modulated based on the power data 343 through the process described with reference to FIG. 5. The NFC antenna L2 may emit the modulated transmission clock signal in the form of a second RF signal and may transmit the second RF signal to the terminal.

Through such a process, the terminal, emitting a first RF signal, may determine a power state of the smart card 300. The terminal may receive the second RF signal to acquire the power data 343 generated by the smart card 300, and may output a representation of the power state of the smart card 300, determined based on the power data 343, through a first user interface.

FIG. 7 is a diagram illustrating a first user interface based on a magnitude of received power of a smart card (e.g., the power state of the smart card) according to an example embodiment of the present inventive concept.

Referring to FIG. 7, a terminal 400 may include a processor executing an application, and a display device 405 displaying a screen according to the application executed by the processor.

When the terminal 400 operates in a reader mode and emits an RF signal, the processor may display, on the display device 405, one of first user interfaces 410 to 450 indicating a strength of power received by a smart card (e.g., the power state) that has approached the terminal 400.

For example, when NFC antennas of the terminal 400 and a smart card are tagged in close proximity to each other, the power state of the smart card may be increased and the processor may receive power data indicating the increase in the received power and output a corresponding power value on the first user interface, as illustrated at 420 and 430. Conversely, when the NFC antennas are tagged at a distance from each other (e.g., no longer in close proximity), the power state of the smart card may be decreased and the processor may receive power data indicating the decrease in the received power and output a corresponding power value on the first user interface, as illustrated at 440 and 450.

A visual method of displaying, by the processor, a magnitude of the power of the smart card on the first user interface is not limited to the screen illustrated in FIG. 7, and the processor may display the magnitude of the power of the smart card in various visual manners.

For example, the processor may display the magnitude of the power of the smart card using a bar-shaped band, and may display the magnitude of the power of the smart card by adjusting a background brightness of a user interface, such as by increasing the background brightness of the user interface as the magnitude of the power of the smart card increases. A user may check a power data value displayed on the first user interfaces 410 to 450, and may move the terminal or the smart card to perform tagging at an optimal position such that the power received by the smart card is maximized as identified by the power data, as illustrated at 430.

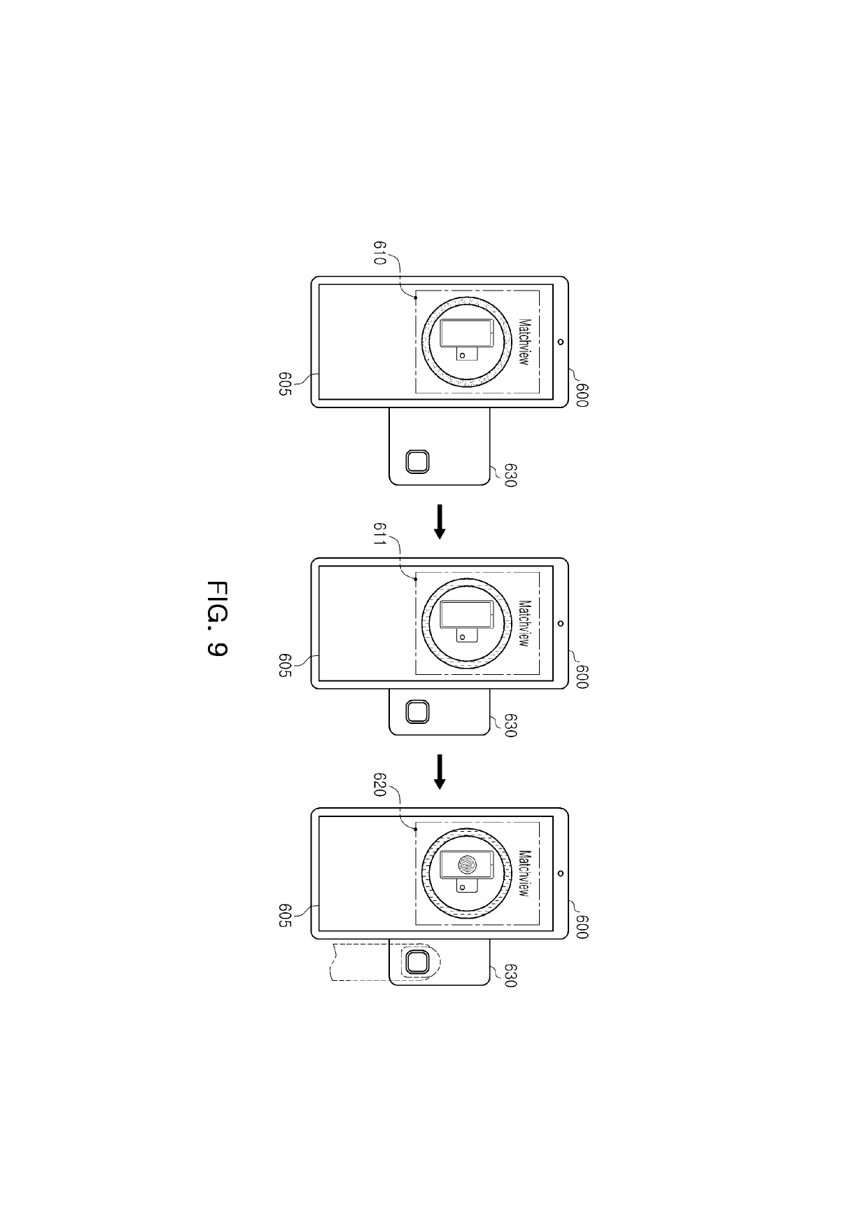

FIG. 8 is a diagram illustrating a process of performing fingerprint registration according to an example embodiment of the present inventive concept.

Referring to FIG. 8, a terminal 500 may include a processor executing an application, and a display device 505 displaying a screen according to the application executed by the processor.

When the terminal 500 operates in a reader mode and emits an RF signal, the processor may display, on the display device 505, one of first user interfaces 510 to 512 indicating a strength of power received by a smart card that has approached the terminal 500 (e.g., a smart card in the process of being tagged with the terminal).

For example, the processor may cause the display device 505 to visually display a circular band shape on the first user interface 510 as a representation of the strength of power received by the smart card, and may cause the first user interface to 510 output a phrase such as “Check Position View”, together with the representation of the strength of power. However, a visual display method is not limited thereto.

As a user appropriately moves at least one of the terminal or the smart card, the strength of power received by the smart card as indicated in the power data may gradually increase and reach a maximum value indicating maximum power. The processor may cause the first user interface 511 to display a representation of a maximum power level (e.g., a full circle on the first user interface 511).

Subsequently, the processor may output, in response to the power level of the smart card, as indicated by the power data, exceeding a preset value, cause a notification indicating a readiness for fingerprint registration to the first user interface 512. For example, the processor may cause the first user interface 512to display the notification in the form of a checkmark icon to instruct the user to perform a fingerprint registration operation, but the form of the icon used to indicate the notification is not limited thereto. In this example, the preset value may refer to a power data value at a point in time at which fingerprint registration is possible in the smart card (e.g., a power level of the smart card necessary for the circuitry of the smart card to register a fingerprint).

Subsequently, in response to performing fingerprint registration, the processor may cause a screen displayed on the display device 505 to switch from the existing first user interface 512 to a second user interface 520 displaying progress of fingerprint registration. With the second user interface 520 being displayed, when a user touches a fingerprint sensor of the smart card 530 with a finger, the smart card 530 may perform the fingerprint registration operation. For example, the processor may receive information on the progress of fingerprint registration from the smart card 530 (e.g., fingerprint registration progress data modulated in the clock signal of the smart cart) and cause the output of a representation of the information to the second user interface 520. When a fingerprint registration process is completed, the processor may cause the second user interface 521 to output a notification indicating that fingerprint registration has been completed.

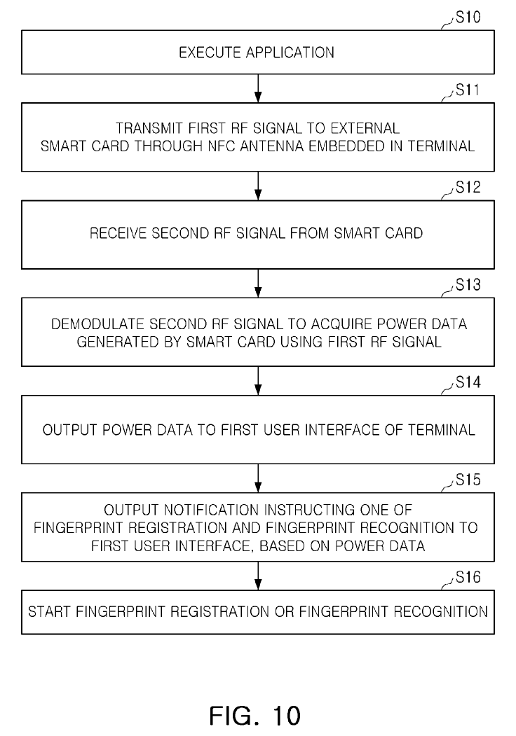

FIG. 9 is a diagram illustrating a process of performing fingerprint recognition according to an example embodiment of the present inventive concept.

Referring to FIG. 9, a terminal 600 may include a processor executing an application, and a display device 605 displaying a screen according to the application executed by the processor.

When the terminal 600 operates in a reader mode and emits an RF signal, the processor may cause the display device 605 to display one of first user interfaces 610 and 611 indicating a strength of power received by a smart card that has approached the terminal 600. For example, the processor may cause the display to visually display a value representing the strength of power as received in power data from the smart card. The value representing the strength of power may be a circular band shape on the first user interface 610, and the processor may cause the first user interface to output a phrase such as “Match View”, together with the value representing the strength of power. However, a visual display method is not limited thereto.

As a user appropriately moves at least one of the terminal or the smart card, the strength of power of the smart card may gradually increase and reach a maximum. Accordingly, the power data received by the terminal may include a value indicating maximum output. The processor may cause the display to output a representation of the maximum power to the first user interface 611. Subsequently, the processor may cause, in response to the value of the strength of power exceeding a preset value, the first user interface 611 to output a notification indicating a readiness for fingerprint recognition. For example, the processor may cause the first user interface 611 to output a fingerprint-shaped icon on the first user interface 611 indicating a readiness for fingerprint recognition. However, the shape of the notification is not limited thereto.

Subsequently, in response to performing fingerprint recognition, the processor may cause the terminal to switch the first user interface 611 to a third user interface 620 displaying progress of fingerprint recognition. The user may perform fingerprint recognition by touching a fingerprint sensor of the smart card with a finger. In this case, the processor may receive, from the smart card, information indicating whether fingerprint information corresponding to the contacted finger matches registered fingerprint information (e.g., such information may be modulated in the clock frequency output by the smart card), and may cause the output of a matching result through the third user interface 620.

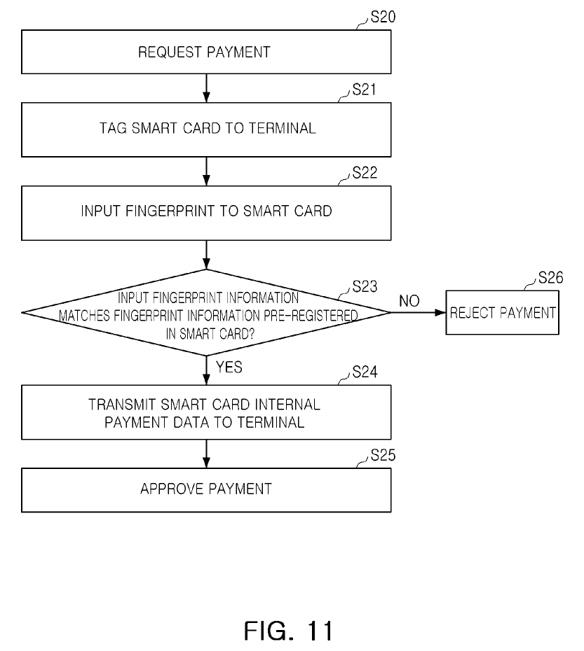

FIG. 10 is a flowchart illustrating a method for registering a fingerprint according to an example embodiment of the present inventive concept.

Referring to FIG. 10, in an example embodiment of the present inventive concept, a processor within a terminal may execute, in response to an execution command of a user, an application (S10).

In an example embodiment of the present inventive concept, the processor may transmit a first RF signal to an external smart card through an NFC antenna embedded in the terminal (S11). The smart card may receive the first RF signal to generate an analog signal, and may acquire power data including information on a strength of power received by the smart card through the analog signal. In addition, the smart card may emit a second RF signal including the power data.

In an example embodiment of the present inventive concept, the processor may receive the power data included in the second RF signal from the smart card (S12). For example, the processor may receive the power data from an RF signal through the NFC communication method described with reference to FIG. 3.

In an example embodiment of the present inventive concept, the processor may receive power data from the second RF signal to acquire power data generated by the smart card using the first RF signal (S13). An NFC module within the terminal may process an analog signal generated in response to the second RF signal generated by the smart card to acquire digital data. The digital data may include power data of the smart card.

In an example embodiment of the present inventive concept, the processor may cause a first user interface of the terminal (S14) to output a representation of the power data. The processor may cause the first user interface of the terminal to visually display a value included in the power data as a circular band shape on the first user interface 510, and to output a phrase such as “Check Position View”, together with the displayed value. However, a visual display method is not limited thereto. For example, the processor may cause the first user interface to display a magnitude of received power using a bar-shaped band, and to display the magnitude of the received power by adjusting a background brightness of a user interface, such as by increasing the background brightness of the user interface as the magnitude of the received power increases.

In an example embodiment of the present inventive concept, the processor may cause the output of a notification indicating a readiness for either fingerprint registration or fingerprint recognition to the first user interface, based on the power data (S15). For example, the processor may cause the output of, by the first user interface, the notification in the form of a checkmark icon to instruct the user to perform a fingerprint registration operation, but the form of the icon used to indicate the notification is not limited thereto.

In an example embodiment of the present inventive concept, the processor may cause the output of, in response to the user performing fingerprint registration or fingerprint recognition, a second user interface or a third user interface (S16). The second user interface may indicate progress of fingerprint registration, and the third user interface may indicate whether fingerprint information input by the user matches pre-registered fingerprint information.

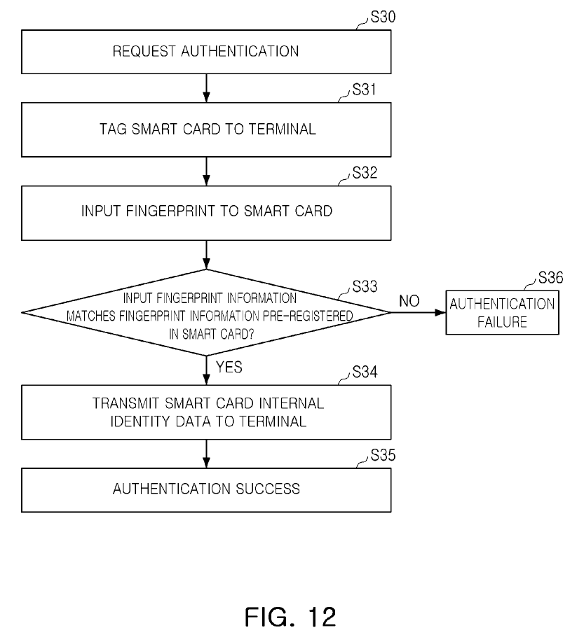

FIGS. 11 and 12 are flowcharts illustrating methods for recognizing a fingerprint according to an example embodiment of the present inventive concept.

Referring first to FIG. 11, a method for performing payment using fingerprint recognition of a smart card is illustrated.

In an example embodiment of the present inventive concept, when a payment request is received (S20), a processor within a terminal may cause the output, in response to tagging a smart card to the terminal (S21), of a first user interface. The processor within the terminal may cause the output of power data through the first user interface, thereby guiding a user to an optimal tagging position. The processor within the terminal may cause the output, based on the power data, of a notification indicating a readiness for a fingerprint recognition operation to the first user interface.

In an example embodiment of the present inventive concept, a user may input a fingerprint by touching a fingerprint sensor of the smart card (S22). Subsequently, a processor in the smart card may determine whether input fingerprint information matches fingerprint information pre-registered in the smart card (S23). Subsequently, in response to the input fingerprint information matching the pre-registered fingerprint information, the processor within the smart card may cause an NFC module in the smart card to transmit smart card internal payment data to the terminal (S24). The processor within the terminal may receive the payment data from an NFC module in the terminal that receives a radio signal containing the payment data from the NFC module of the smart card, perform a payment approval process, and cause the output of a payment approval notification to a third user interface (S25).

In an example embodiment of the present inventive concept, in response to the input fingerprint information mismatching the pre-registered fingerprint information, the processor within the smart card may cause the NFC module of the smart card to transmit mismatch information to the terminal. The processor within the terminal may cause the output of a payment rejection notification to the third user interface (S26).

Referring to FIG. 12, a method for performing identity authentication using fingerprint recognition of a smart card is illustrated.

In an example embodiment of the present inventive concept, a processor within a terminal may receive an authentication request (S30). In this example, the processor within the terminal may cause an output, in response to tagging a smart card to a terminal (S31), of a first user interface. The processor within the terminal may cause the output of power data through the first user interface, thereby assisting a user in guiding a smart card to an optimal tagging position.

In an example embodiment of the present inventive concept, the user may input a fingerprint by touching a fingerprint sensor of the smart card (S32). Subsequently, a processor within the smart card may determine whether input fingerprint information matches fingerprint information pre-registered in the smart card (S33). Subsequently, in response to the input fingerprint information matching the pre-registered fingerprint information, the processor within the smart card may transmit smart card internal identity data to the terminal (S34) (e.g., through an NFC module of the smart card). The processor within the terminal may receive the identity data from the smart card, perform an identity authentication success process, and cause the output of an identity authentication success notification to a third user interface (S35).

In an example embodiment of the present inventive concept, in response to the input fingerprint information mismatching the pre-registered fingerprint information, the processor within the smart card may transmit mismatch information to the terminal. The processor within the terminal may then cause an output of an identity authentication failure notification to the third user interface (S36).

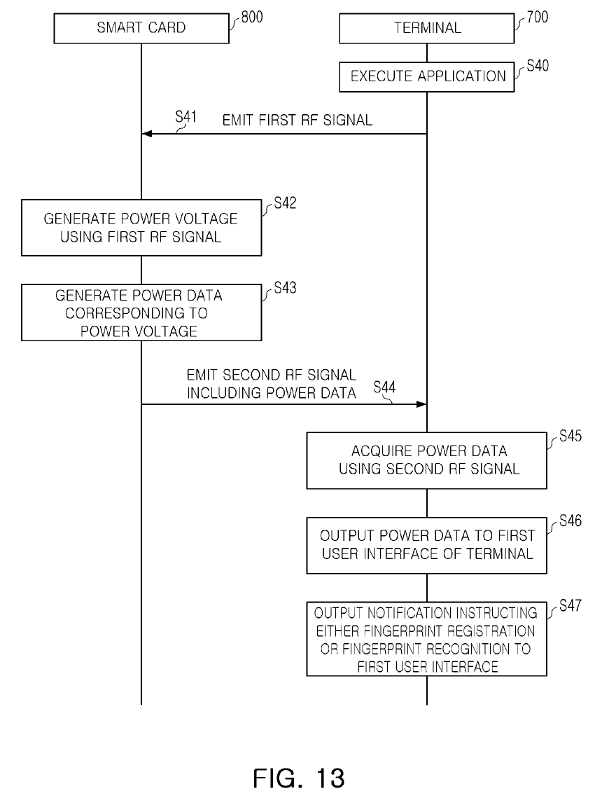

FIG. 13 is an operation diagram illustrating an operation process of a terminal and a smart card according to an example embodiment of the present inventive concept.

Referring to FIG. 13, an operation process of a terminal 700 and a smart card 800 is illustrated.

In an example embodiment of the present inventive concept, a processor within the terminal 700 may execute an application within the terminal (S40). Thereafter, an NFC antenna in the terminal 700 may emit a first RF signal (S41). When a tagging notification is displayed within the application, a user may tag a smart card to the terminal 700.

In an example embodiment of the present inventive concept, a smart card 800 may generate a power voltage using the first RF signal (S42). For example, an NFC antenna within the smart card 800 may output, in response to the first RF signal emitted from an external terminal, an analog signal. Thereafter, a rectifier within the smart card 800 may rectify the analog signal and output a rectification voltage. Subsequently, a voltage regulator within the smart card 800 may generate a power voltage from the rectification voltage.

In an example embodiment of the present inventive concept, the smart card 800 may generate power data including a power state of the smart card such as information representing the power voltage (S43). In an example embodiment, a power state detector within the smart card 800 may include a current mirror transistor copying a current input from the rectifier to the voltage regulator, and may generate the power data using a mirror current output by the current mirror transistor.

In an example embodiment of the present inventive concept, the smart card 800 may emit a second RF signal including the power data (S44). In an example embodiment, a modulator within the smart card 800 may output a transmission clock signal modulated based on the power data to the NFC antenna. Thereafter, the NFC antenna may convert the transmission clock signal into the second RF signal and emit and transmit the second RF signal to the terminal 700.

In an example embodiment of the present inventive concept, the terminal 700 may acquire the power data using the second RF signal (S45). In an example embodiment, the NFC antenna within the terminal 700 may receive the second RF signal. Thereafter, an NFC module within the terminal 700 may process an analog signal generated by the NFC antenna in response to the second RF signal externally introduced to acquire digital data. The digital data may include the power data of the smart card.

In an example embodiment of the present inventive concept, a processor within the terminal 700 may cause the output of the power data to a first user interface of the terminal (S46). In an example embodiment, the processor may execute the application, and may cause the output of the power data indicating a strength of power received by the smart card, to the first user interface through the application.

In an example embodiment of the present inventive concept, a processor within the terminal 700 may cause the output, to the first user interface, of a notification indicating a readiness for either fingerprint registration or fingerprint recognition (S47). For example, the processor may cause the output of a fingerprint-shaped icon to the first user interface to instruct a user to perform a fingerprint recognition operation. However, the shape of the notification is not limited thereto, and icons having various shapes may be output to the first user interface.

According to example embodiments of the present inventive concept, while a smart card enters an NFC field generated by an external terminal and receives an RF signal from the external terminal, the external terminal may detect a strength of power generated by the smart card. The smart card may transmit, through NFC communication, power data indicating power generated by receiving the RF signal to the external terminal. An application executed within the external terminal may display a power state of the smart card on a user interface. Accordingly, a user may recognize a magnitude of the RF signal received by the smart card, and a tagging position of the smart card with respect to the external terminal may be effectively optimized.

While example embodiments have been shown and described above, it will be apparent to those skilled in the art that modifications and variations could be made without departing from the scope of the present disclosure as defined by the appended claims.

What is claimed is:

1. A terminal comprising:
a near field communication (NFC) antenna;
an NFC module configured to emit a first radio frequency (RF) signal through the NFC antenna, and configured to acquire digital data from an analog signal generated from a second RF signal received by the NFC antenna; and
a processor configured to execute an application providing a first user interface using the digital data,
wherein the digital data includes power data of a smart card emitting the second RF signal, and
wherein the processor is configured to output the power data to the first user interface of the terminal to present a representation of a power state of the smart card.

2. The terminal of claim 1, wherein the processor is configured to output, in response to the power data having a power value exceeding a preset value, a notification, indicating a readiness for one of fingerprint registration and fingerprint recognition, to the first user interface.

3. The terminal of claim 2, wherein the processor is configured to switch, in response to the power data having the power value exceeding the preset value, the first user interface to a second user interface configured to display a progress of the fingerprint registration.

4. The terminal of claim 2, wherein the processor is configured to switch, in response to the power state having the power value exceeding the preset value, the first user interface to a third user interface configured to display whether fingerprint information corresponding to a contacted finger matches registered fingerprint information.

5. The terminal of claim 1, wherein the processor is configured to set, in response to performing one of fingerprint registration and fingerprint recognition, a level of RF output power of the terminal to a maximum level.

6. The terminal of claim 4, wherein the processor is configured to output, in response to the fingerprint information corresponding to the contacted finger matching the registered fingerprint information, a recognition success notification to the third user interface.

7. The terminal of claim 4, wherein the processor is configured to output, in response to the fingerprint information corresponding to the contacted finger mismatching the registered fingerprint information, a recognition failure notification to the third user interface.

8. The terminal of claim 2, wherein the preset value is a power level of the smart card necessary for the smart card to perform the fingerprint registration.

9. A method for registering and recognizing a fingerprint, the method comprising:
transmitting a first RF signal to an external smart card through an NFC antenna of a terminal;
receiving a second RF signal from the external smart card in response to the first RF signal;
demodulating the second RF signal to acquire power data generated by the external smart card using the first RF signal;
outputting the power data to a first user interface of the terminal to cause the first user interface to present a representation of a power state of the external smart card; and
outputting, to the first user interface, a notification indicating a readiness one of fingerprint registration and fingerprint recognition, based on the power data.

10. The method of claim 9, further comprising:
updating the presentation of the first user interface to a presentation of a second user interface displaying progress of a fingerprint registration operation in response to performing the fingerprint registration operation.

11. The method of claim 9, further comprising:
switching the first user interface to a third user interface displaying whether fingerprint information corresponding to a contacted finger matches registered fingerprint information in response to performing a fingerprint recognition operation.

12. The method of claim 9, wherein the transmitting the first RF signal includes setting, in response to a tagging of the external smart card to the terminal, a level of RF output power of the terminal to a maximum level of the terminal.

13. The method of claim 9, wherein the outputting the notification to the first user interface includes outputting, in response to the power data having a power value exceeding a preset value, the notification to the first user interface.

14. The method of claim 13, wherein the preset value is a value required for the external smart card to perform the fingerprint registration.

15. A smart card comprising:
an NFC antenna configured to output, in response to receiving a first RF signal emitted by an external terminal, an analog signal;
a rectifier configured to rectify the analog signal and output a rectification voltage;
a voltage regulator configured to provide a power voltage using the rectification voltage;
a power state detector including a current mirror transistor configured to copy a current input from the rectifier to the voltage regulator, the power state detector configured to generate power data representing a power state of the smart card using a mirror current output by the current mirror transistor; and
a modulator configured to output, to the NFC antenna, a transmission clock signal modulated based on the power data.

16. The smart card of claim 15, wherein the smart card further includes:
a fingerprint sensor powered by the power voltage, the fingerprint sensor configured to generate fingerprint information based on a fingerprint sensed by the fingerprint sensor; and
a processor powered by the power voltage, the processor configured to perform at least one of fingerprint registration and fingerprint recognition based on the fingerprint information.

17. The smart card of claim 16, wherein the smart card further includes a memory powered by the power voltage, the memory configured to store the fingerprint information received from the fingerprint sensor.

18. The smart card of claim 15, wherein the NFC antenna is configured to emit, to the external terminal, a second RF signal generated based on the transmission clock signal modulated based on the power data.

19. The smart card of claim 16, wherein the processor is configured to generate fingerprint registration progress data, the modulator is configured to modulate the transmission clock signal based on the fingerprint registration progress data, and the NFC antenna is configured to transmit, in response to performing fingerprint registration, the fingerprint registration progress data to the external terminal.

20. The smart card of claim 16, wherein the processor is configured to generate fingerprint match data, the modulator is configured to modulate the transmission clock signal based on the fingerprint match data, and the NFC antenna is configured to transmit, in response to performing fingerprint recognition, the fingerprint match data to the external terminal.
